(19) United States
(12) Patent Application Publication
(10) Pub. No.: US 2014/0118118 A1
(43) Pub. Date: May 1, 2014

(54) REMOTE CONTROLLER FOR TENNIS BALL THROWING MACHINE

(71) Applicant: LUCK STONE CORPORATION, Richmond, VA (US)

(72) Inventors: Charles Patrick Hanssen, Earlysville, VA (US); Timothy Clark Beyer, Zion Crossroads, VA (US)

(73) Assignee: LUCK STONE CORPORATION, Richmond, VA (US)

(21) Appl. No.: 13/660,093

(22) Filed: Oct. 25, 2012

(51) Int. Cl. G08C 19/16

(52) U.S. Cl. 340/12.5

(57) ABSTRACT

A tennis ball throwing machine includes a processor mounted on the machine. The processor is operatively connected to a first receiver that is adapted to communicate with the processor and to receive instructions regarding the operation of the machine. A remote controller includes a first transmitter for transmitting signals from the remote controller regarding the operation of the machine. The remote controller includes an interface having start/stop control of the machine. The remote controller has two-way communication with the ball machine processor.

The field of the invention is tennis ball throwing machines. The remote controller may actively interact bidirectionally with the machine by transmitting information to and receiving information from the machine.

### BACKGROUND

Tennis ball throwing machines have been widely used for many years in connection with practice and drills by tennis players. Initiating the operation of the throwing machine has always been challenging for tennis ball throwing machines. This challenge has been solved at present by initial delays in throwing the first ball to allow a user to cross a court and get into a ready position after activating a machine. Another solution has been the use of manually held remote controls that allow a user to stand away from a ball machine before initiating the use of the machine.

The trouble with existing remote control devices and tennis ball machines is that a user may start a machine and then throw the remote control device to the side of the court to not interrupt any shots. Inevitably, the remote controls are inadvertently abused and can get very dirty and even disabled as a result of the use.

Another limiting aspect of current remote controllers is that they are one-way. In other words, there is instruction and activation that may be initiated by a user. However, there is no communication from a machine back to a remote controller. The actions that may be initiated by the remote controller are limited to whatever menu of actions are embedded in the remote controller.

### SUMMARY

Accordingly, it is an object of the present of the present invention to overcome the existing limitations with current remote controllers. A remote controller may have two-way communication with a tennis ball throwing machine so that information provided by the machine may be displayed on the remote controller.

In one example, a tennis ball throwing machine comprises a throwing machine and a processor mounted on the machine. The processor controls the operation of the machine including speed, spin, height, location and frequency of the throws. A first receiver is operatively connected to the process and adapted to communicate with the processor and to receive instructions regarding the operation of the machine. A remote controller comprises a first transmitter for transmitting signals to the first receiver regarding the operation of the machine. The first transmitter and first receiver are in operative communication with each other. The remote controller comprises an interface having start/stop control of the machine. The remote controller interface may display a plurality of options for different drill set instructions. The remote controller may further comprise a physiological detector for detecting a physiological attribute of a user wearing the remote controller. The detected results of the physiological attribute may be transmitted to the processor. The machine may further comprise a portable memory device that is in operative communication with the processor. Information regarding the information of the machine is adapted to be saved in the portable memory device. The processor may further comprise a second transmitter and the remote controller further comprise a second receiver with the second transmitter and second receiver in operative communication with each other. The processor may contain a plurality of drill sets of instructions that are transmitted by the second transmitter to the remote controller and displayed on the remote controller interface so that a user can select from the plurality of drill set instructions and activate a start/stop drill set instruction on the machine. The detected results of a physiological attribute that are detected by the remote controller may be transmitted to the processor and those results are adapted to be saved on the portable memory device. The portable memory device may further contain a plurality of drill sets of instructions that are transmitted by the second transmitter to the remote controller and displayed on the remote controller interface so that a user can select from the plurality of drill set of instructions and activate a start/stop drill set instruction on the machine.

### BRIEF DESCRIPTION OF THE DRAWINGS

FIG. 1 is a functional flow chart illustrating the bidirectional communication between a remote controller, tennis ball throwing machine processor and portable memory device.

FIGS. 2A-2C are perspective views of examples of wristband remote controllers. FIG. 2A is a remote controller with a plastic wristband and buckle.

FIG. 2B is a remote controller with a wristband having a hook and loop fastener.

FIG. 2C is a remote controller mounted on an elastic, fabric wristband.

FIG. 3 is a perspective view of a representative tennis ball throwing machine.

FIG. 4 is a rear perspective view of a tennis ball throwing machine.

### DETAILED DESCRIPTION

A wristband remote controller for use with a tennis ball throwing machine may operate unidirectionally or, alternatively, bidirectionally. In the unidirectional alternative, the remote controller includes within it an electronic transmitter for sending wireless signals. The tennis ball throwing machine includes a processor having a receiver for receiving the wireless signals that are sent by the remote controller. In the bidirectional alternative, the remote controller includes both a transmitter and a receiver. Similarly, the tennis ball throwing machine processor includes both a transmitter and receiver. In this alternative, the remote controller and machine processor are each able to both send signals to the other and receiver signals from the other.

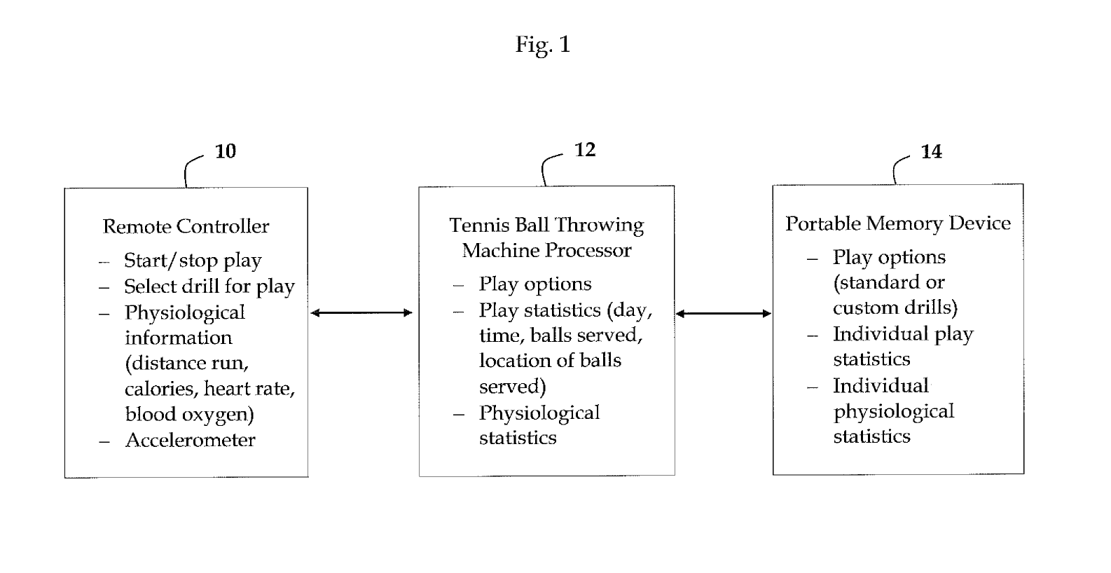

Turning now to FIG. 1, there is shown schematically the examples of various types of instructions and information that may be exchanged between a remote controller 10, a tennis ball throwing machine processor 12, and optionally a portable memory device 14. As noted earlier, the information in the form of electronic signals may be exchanged one-way or bidirectionally. In FIG. 1, the remote controller 10 is shown communicating bidirectionally with the tennis ball throwing machine processor 12 by way of the double arrows between those devices. As noted, it is possible for the remote controller 10 to contain only a transmitter that sends information/instructions to a machine processor 12 that only incorporates a receiver.

A tennis ball throwing machine is operated and controlled by a machine processor 12. The machine processor 12 will trigger the operation of the machine with respect to the actual throwing of tennis balls for use in a drill. The machine processor 12 typically presents alternative play options to a user. In some advanced versions of tennis ball throwing machines, a record of play statistics is maintained in a machine processor 12. These statistics may include such facts as the date and time of a throwing drill session. It may remember the number of balls served and the location of those balls. Additional information including the types of strokes and sequence of strokes may also be recorded for statistical purposes and later referenced by a user of a tennis ball throwing machine. The machine processor may also record and store physiological statistics of a user. This includes basic information such as age, height and weight. However, when used in connection with a physiological detector, the type of information that may be recorded and saved includes heart rate, calories burned, distance run, blood oxygen and other information.

In alternative examples of tennis ball throwing machines, a processor such as processor 12 may have multiple play options programmed into it. These play options may be generic, preprogrammed workouts that are intended for general types of common tennis drills. Additionally, the play options may further include drills or other practice sets that have been custom-created. These custom drills may be created by a user. Alternatively, the may be created by a third party such as a teaching professional or instruction school generally for some special purposes or workouts. There may be third party commercial packages that would be available for sale that could be downloaded into a processor 12 that a user may select. All of this description is merely exemplary and not limiting. There may additional options for selecting and using tennis drills and creating those drills that may be developed in alternative tennis ball throwing machines.

Likewise, various types of play statistics and physiological statistics may be retained in a machine processor 12. This may include administrative-type statistics such as the total usage of a machine and number of balls thrown. This could be used to estimate regular maintenance needs for a particular machine. The play statistics may also be retained for specific individuals or groups of individuals that use the machine. The maintenance and record of these statistics will have various alternative uses and relevance for both the owner of the machine and user or users of the machine.

The remote controller 10 optionally includes several different functionalities. In a basic example, a remote controller 10 includes the ability to start and stop play of a tennis ball throwing machine. In this basic example, the remote controller requires only a transmitter to send a wireless signal to a receiver in the tennis ball throwing machine processor to activate and deactivate the play of the machine. In another example of a remote controller 10, there is a graphic user interface or other physical button that allows a user to select a particular drill for play. In a one-way alternative, the remote controller has a pre-set drill or selection of drills that a user may activate. In a bidirectional alternative, a tennis ball throwing machine processor 12 will transmit to a remote controller the various options for play and particular drills that are available to be activated on the tennis ball throwing machine.

The remote controller 10 may further include a display of physiological information. This information may include the distance run by a user, the calories burned, the heart rate, the blood oxygen, or any other information that may be detected by a remote controller. This physiological information may be detected and displayed solely on a remote controller 10. In another alternative, this physiological information may be transmitted to a tennis ball throwing machine processor 12 for storage. In a still further alternative, the remote controller 10 may retrieve some physiological statistic information from a tennis ball throwing machine processor 12 for display to a user to be able, for instance, to review and compare historical physiological information with current information that is being detected.

The remote controller 10 may additionally include an accelerometer incorporated therein. The accelerometer is adapted to track the movement and speed of movement of a wristband remote controller 10, thereby tracking the movement and speed of movement of the arm of the tennis user. Specifically, when the wristband remote controller 10 is fixed on the playing arm of a user, that is the arm that actually swings the tennis racket, then the accelerometer component in the remote controller can determine when the user is undertaking a swing to hit a tennis ball. In other words, there is movement of the wrist of a user during regular play, but when the wrist and arm of the user is swinging to hit a tennis ball, then that rapid movement can be detected by an accelerometer. In use, this may enable the wristband remote controller to signal the tennis ball throwing machine when the user has hit a tennis ball during a drill. This could be used to signal when another ball could be thrown from the machine.

A portable memory device 14 may also be used in connection with a tennis ball throwing machine processor 12. In general terms, a portable memory device 14 may have saved in it various play options for instructing the operation of the tennis ball throwing machine. These play options may be standard or pre-set options as earlier discussed. Alternatively, a portable memory device 14 may include custom drills or play options that may be created by the user or other third parties. A portable memory device memory device 14 may include individual play statistics and individual physiological statistics as well.

The portable memory device 14 may be linked to a tennis ball throwing machine processor 12 by means of a physical port such as a USB port where the portable memory device may be a memory stick. Other physical types of connection between a portable memory device 14 and tennis ball throwing machine processor 12 are possible. The link between the portable memory device 14 and tennis ball throwing machine processor 12 may also be wireless.

As demonstrated in FIG. 1, a remote controller 10, tennis ball throwing machine processor 12 and portable memory device 14 may all communicate bidirectionally through a tennis ball throwing machine processor for control of the tennis ball throwing machine and for the retention of various play drill options and play statistics and physiological statistics.

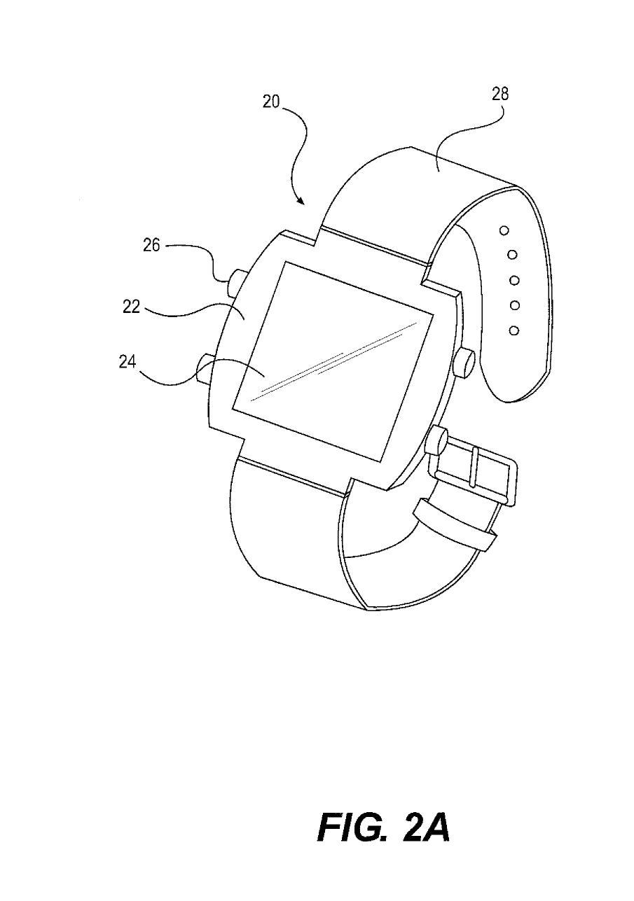

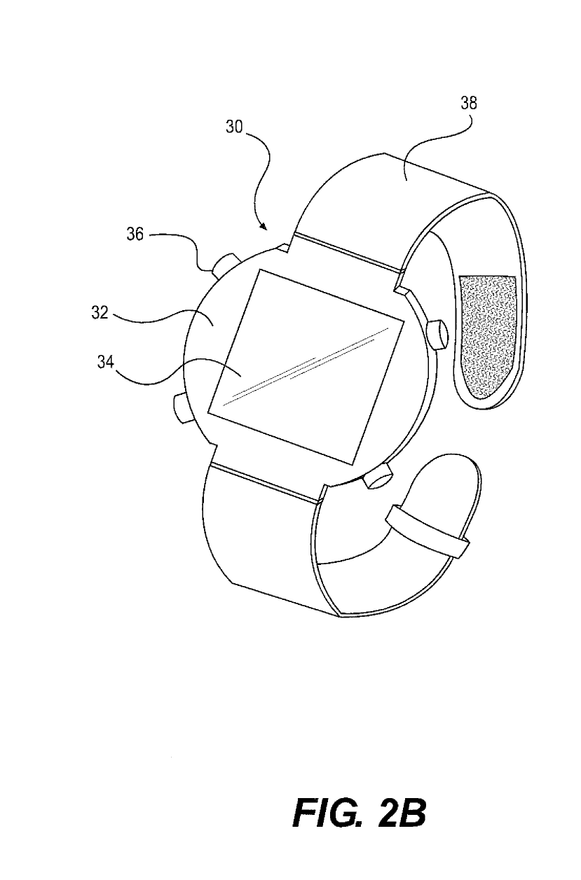

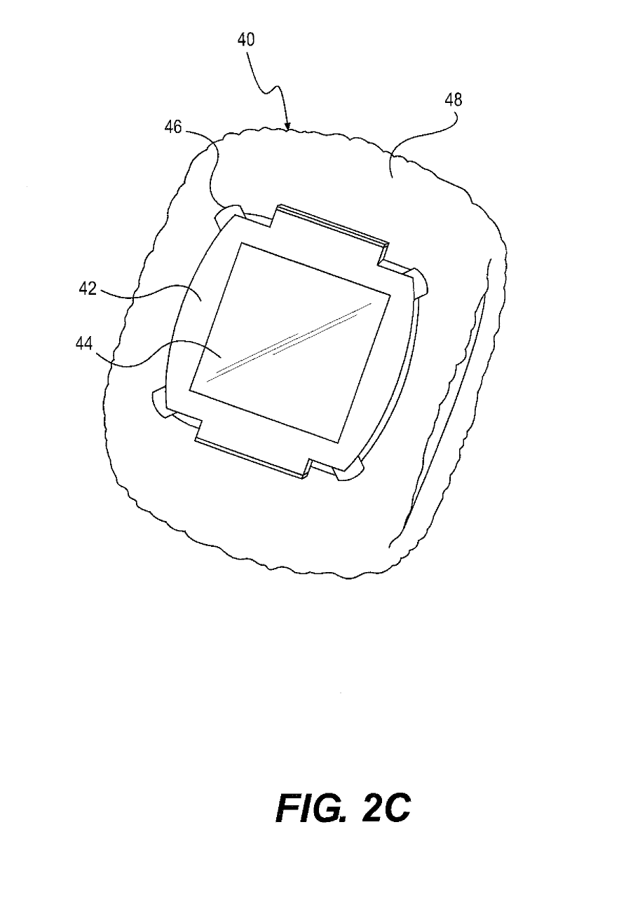

Turning now to FIGS. 2A-2C, there are shown alternative examples of wristband remote controllers 20, 30 and 40 respectively. In FIG. 2A, remote controller 20 includes a housing 22 and a graphic user interface 24. The remote controller 20 further comprises multiple buttons 26. The user is able to operate a tennis ball machine by activating various signals using the buttons 26 or, alternatively, through a touch screen as shown in the user interface 24. A transmitter and/or receiver is fixed in the housing 22. A wristband 28 is connected to the housing 22. The plastic wristband 28 is preferably formed of a smooth plastic that may be wiped off between uses. Since the remote controller 20 may be worn by multiple users, it is very possible that sweat and other germs may be left on the plastic band 28.

Referring to FIG. 2B, the wristband controller 30 contains a housing 32, a graphic user interface 34 and push control buttons 36. Like the earlier wristband remote controller 20, the user may activate the operation of a tennis ball throwing machine by using the buttons 36 alone or in combination with the user interface 34 touch screen. The wristband 38 is a hook and loop type fastener band that may be releasably fashioned to fit snugly around the wrist of a user.

In FIG. 2C, the remote controller 40 includes a housing 42 with a graphic user interface 44 and control buttons 46. As with the earlier remote controllers 20 and 30, a user may activate the operation of a tennis ball throwing machine using one or more of the buttons 46 alone or and in connection with a possible touch screen as demonstrated in the graphic interface 44. The wristband 48 is shown as an elastic band such as a common sweat band that a tennis player may use and wear on their wrist. The housing 42 may be permanently secured to the wristband 48. Alternatively, the housing 42 may be releasably secured so that each individual may use their own personal wristband 48 or, still further alternatively, may use a new wristband with each use in order to prevent any spread of germs and sweat. In each example, the wristbands 28, 38 and 48 are designed to fit securely and snug tight to a user's wrist.

Although not shown, each of the remote controllers 20, 30 and 40 may include functionality that detects physiological traits such as heart rate, blood oxygen and other information. These detectors would be typically embedded in the back of the housings 22, 32 or 42 or, still further alternatively, within the wristbands 28, 38 or 48 and in contact with a user's skin. The respective housings 22, 32 and 42 may also contain such functionality as a GPS detector which may track and store the movement of a user during a workout.

FIGS. 2A-2C show a wristband style of remote controller. While there are benefits to wristband devices, other devices such as cords or necklaces or bands or special clothing or other hardware may be used to carry and embody the remote controller.

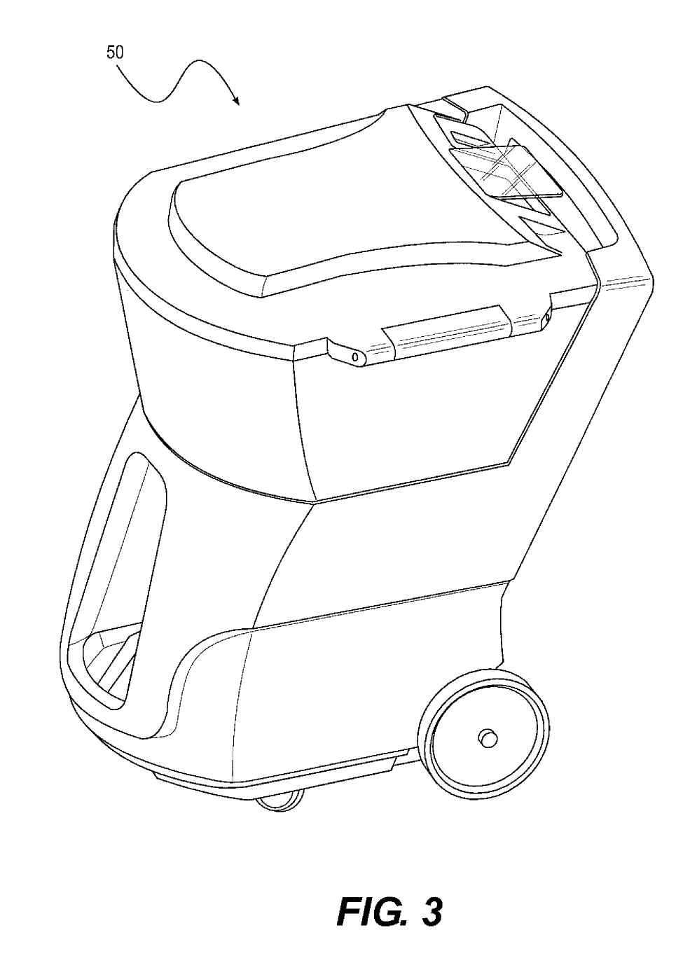

FIG. 3 is a perspective view of a tennis ball throwing machine 50. This tennis ball throwing machine is traditionally portable and may be rolled out onto a court for use and then rolled away from the court when traditional play goes forward between two or more players.

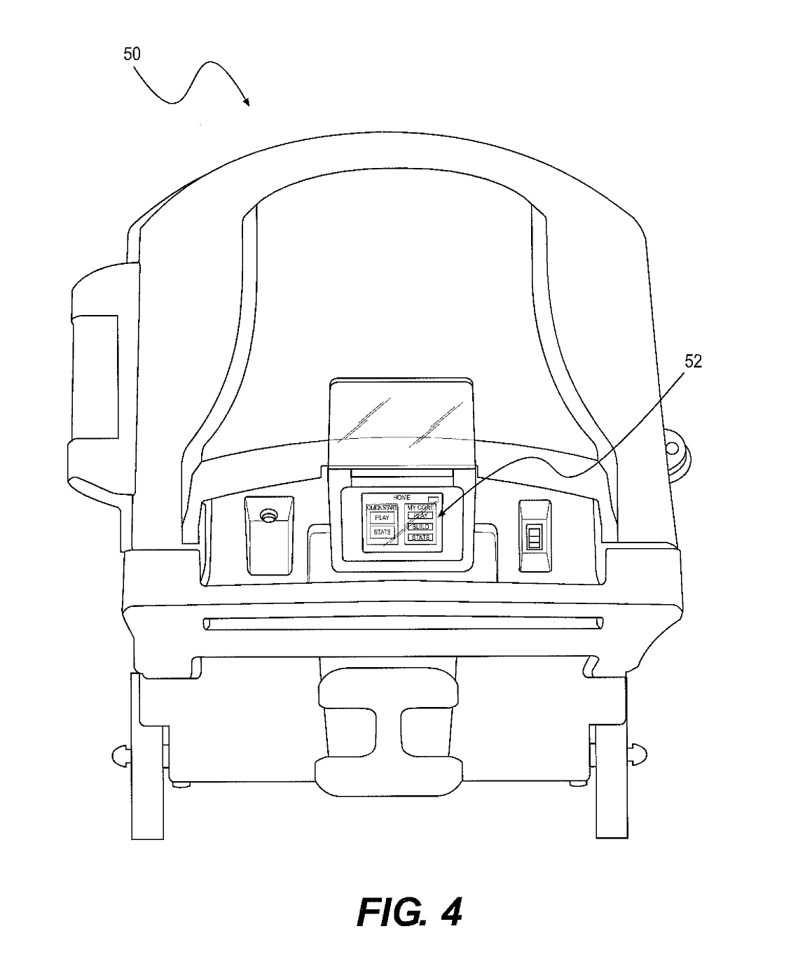

FIG. 4 is a rear perspective view of the tennis ball throwing machine 50 shown in FIG. 3. This FIG. 4 shows the tennis ball throwing machine processor interface 52 that communicates with the remote controller and, optionally, with a portable memory device as described earlier herein.

Other embodiments of the present invention will be apparent to those skilled in the art from consideration of the specification. It is intended that the specification and Figures be considered as exemplary only, with a true scope and spirit of the invention being indicated by the following claims.

That which is claimed is:

1. A tennis ball throwing machine comprising:
a throwing machine;
a processor mounted on the machine, the processor controlling the operation of the machine including the speed, location and frequency of the throws;
a first receiver operatively connected to the processor, the first receiver adapted to communicate with the processor and to receive instructions regarding the operation of the machine;
a second transmitter operatively connected to the processor;
a remote controller comprising a first transmitter for transmitting signals to the first receiver regarding the operation of the machine, and the first transmitter and first receiver are in operative communication with each other;
the remote controller comprising a second receiver, and the second transmitter and second receiver are in operative communication with each other; and
the remote controller comprising an interface having start/stop control of the machine.

2. A tennis ball throwing machine as described in claim 1, wherein the remote controller interface displays a plurality of options for different drill set instructions.

3. A tennis ball throwing machine as described in claim 1, wherein the remote controller further comprises a physiological detector for detecting a physiological attribute of a user wearing the remote controller;
and wherein the detected results of the physiological attribute are transmitted to the processor.

4. A tennis ball throwing machine as described in claim 1, the machine further comprising a portable memory device, wherein the processor is adapted to operatively communicate with the portable memory device;
and information regarding the operation of the machine is adapted to be saved in the portable memory device.

5. A tennis ball throwing machine as described in claim 1, wherein the processor contains a plurality of drill sets of instructions that are transmitted by the second transmitter to the remote controller and displayed on the remote controller interface, and a user can select from the plurality of drill set instructions and activate a start/stop drill set instruction on the machine.

6. A tennis ball throwing machine as described in claim 4,
wherein the remote controller further comprises a physiological detector for detecting a physiological attribute of a user wearing the remote controller;
and wherein the detected results of the physiological attribute are transmitted to the processor;
and wherein the detected results of the physiological attribute are adapted to be saved on the portable memory device.

7. A tennis ball throwing machine as described in claim 4, wherein the portable memory device contains a plurality of drill sets of instructions that are transmitted by the second transmitter to the remote controller and displayed on the remote controller interface, and a user can select from the plurality of drill set instructions and activate a start/stop drill set instruction on the machine.
